(19) United States
(12) Patent Application Publication
(10) Pub. No.: US 2026/0119133 A1
(43) Pub. Date: Apr. 30, 2026

(54) System and method for generating source code of a software application based on behavior analysis

(71) Applicant: Bank of America Corporation, Charlotte, NC (US)

(72) Inventors: Jack Bishop, Evanston, IL (US); Jason C. Starin, Huntersville, NC (US); Timothy Andrew Wright, Berkshire (GB)

(21) Appl. No.: 18/927,073

(22) Filed: Oct. 25, 2024

(51) Int. Cl. G06F 8/35

(52) U.S. Cl. CPC G06F 8/35

(57) ABSTRACT

A system for generating source code for a software application based on behavioral analysis of the software application is disclosed. The system obtains an input data stream provided to the software application and a corresponding output data stream generated by the software application. In response, the system determines a relationship and correlation between each series of inputs and the respective output and generates a set of input-output pairs. The system clusters each subset of input-output pairs that are associated with a specific function of the software application. The system generates a source code portion for each cluster of input-output pairs that are associated with a specific function of the software application. The system aggregates and finalizes the source code portions. The system executes the finalized source code.

### TECHNICAL FIELD

The present disclosure relates generally to network security, and more specifically to a system and method for generating source code of a software application based on behavior analysis.

### BACKGROUND

Software applications are used to provide certain functionalities for data analysis. If the source code of a software application is no longer available, accessing and updating the functions of the software application is challenging.

### SUMMARY

The disclosed system, described in the present disclosure, is particularly integrated into a practical application of implementing and improving methods for recovering software applications’ functions through behavioral analysis of software applications – specifically when the source code of a software application is not available. This practical application provides several technical advantages, including conserving computational and network resources that would otherwise be used to reverse engineer the source code of the software application (which is prone to errors and inaccurate). Another technical advantage of this practical application is conserving computational and memory storage resources that would otherwise be used to store obsolete code files in a database and execute those obsolete code files.

In conventional systems, there may be cases where source code associated with a software application is no longer available. For example, the software application may be a legacy/outdated application or a compromised application where bad actors have hijacked its source code. One approach may be to attempt to reverse engineer the software application. However, this approach suffers from several drawbacks. In some examples, reverse engineering often does not result in accurate source code of the software application because of the complexity of the function of the software application and/or the relevant manual documents associated with the software application not being available or otherwise not well documented.

The disclosed system is configured to provide a technical solution to these and other technical problems in the realm of software application’s behavioral function recovery. The disclosed system provides several technical improvements to the software application’s behavioral function recovery technology. Some of these technical improvements are described below in conjunction with certain embodiments of the disclosed system.

In some embodiments, instead of attempting to reverse engineer the software application in question, the disclosed system may analyze the behavior of the software application by capturing and analyzing input-output relationships related to various functions of the software application, generating a set of clusters of input-output pairs for each identified function, and generating a source code portion that when executed by a processor, causes the processor to perform a given function. These operations are described in greater detail below.

In some embodiments, analyzing input-output relationships related to various functions of the software application may include detecting a temporal relationship between a sequence of events (e.g., inputs) that results in the given output from the software application. For example, the disclosed system may determine that when a series of particular events occur (e.g., certain conditions are met, a specific order of inputs is provided to the software application, etc.), the software application generates the respective output. Therefore, the disclosed system may detect the temporal factor between the given series of events that led to the respective output. Thus, the disclosed system may detect complex temporal dependencies and patterns within the inputs, and the coloration between each ordered inputs and the respective outputs of the software application 130.

In some cases, the disclosed system may detect that an input A has led to multiple outputs by the software application on separate occasions. The disclosed system may determine the reason for this anomaly by simulating and analyzing various orders of inputs followed by the input A to the software application to determine the effect of previous one or more inputs on the software application. In response, the disclosed system may discover a specific sequence of prior inputs (e.g., user inputs, conditions, events) that caused the software application to generate different outputs from the same input A. As an example, the disclosed system may detect a request to compile a piece of code (an input A) that has led to different outputs by the software applications on separate occasions. In one instance, the software application may compile the code with no errors, in another instance, with the same input, the software application may generate an error message. The disclosed system may simulate previous input(s)/event(s) for each instance and determine whether the code had been modified in earlier steps and whether specific libraries were included or omitted from the code, among others. In response, by analyzing the prior input(s)/event(s) and their temporal relationships, the disclosed system may determine the effect of the prior input(s)/event(s) and their temporal relationships on the behavior of the software application. In response, the disclosed system may identify that the different outputs are caused by the specific sequences of prior inputs followed by the same input A, respectively. In this manner, the disclosed system may uncover and model complex temporal and behavioral functions of the software application on various occasions.

In some embodiments, the disclosed system is configured to cluster a given subset of input-output pairs that are determined to be related to the same function of the software application. The disclosed system may generate multiple function-specific clusters of input-output pairs. In response, the disclosed system may implement a code generating machine learning algorithm to generate a source code portion for each function-specific cluster. The disclosed system may aggregate the generated source code portions, and identify and remove the duplicate code snippets. The disclosed system may generate a finalized source code that behaves as the software application would. In this way, the disclosed system is configured to generate source code that reflects the software application’s functional behavior. For example, the disclosed system provides a solution to recover and generate the source code of a compromised software application that is hijacked by bad actors, and generate and update the source code of a legacy software application whose source code is no longer available.

The disclosed system may conserve computational resources that would otherwise be used to execute obsolete or outdated functions of a software application. For example, the disclosed system may detect obsolete or outdated functions of a software application based on comparing with the currently executed and in-demand functions of the software application and generate source code from which those obsolete or outdated functions are removed. In response, code files or code portions of the source code may be removed. Thus, the newly generated source code requires fewer memory resources to be maintained. Further, the newly generated source code improves the memory and processing resource utilization at computer systems that host the source code to perform the functions of the software application. For example, by removing the obsolete or outdated functions of a software application, the disclosed system obviates the need to allocate processing resources to execute and handle those obsolete functions of the software application.

The disclosed system may reduce the likelihood of anomalous data being propagated to and processed by downstream computing devices of the software application in question. For example, as a result of obsolete or outdated functions of the software application being executed, anomalous data (e.g., incompatible data formats, corrupted data, incorrect API calls, or unexpected parameter values) may be generated by the software application. If there is no provision to detect and mitigate such anomalous data, they may be communicated to downstream computer systems. This, in turn, leads to additional anomalous data being generated by the downstream computer systems, and system errors occur at the downstream computer devices—which results in performance degradation and/or crashes at the downstream computer systems. Further, the additional anomalous data wastes memory resources at the downstream databases. By detecting and mitigating obsolete or outdated functions, and therefore, anomalous data, the disclosed system reduces the likelihood of such issues across the downstream computer systems and databases.

In some embodiments, a system comprises a memory operably coupled with a processor. The memory is configured to store a software application associated with a set of operations comprising a first operation and a second operation. The processor is configured to obtain an input data stream communicated to the software application and a corresponding output data stream generated by the software application. The processor is further configured to determine a set of input-output pairs based, at least in part, upon the obtained input data stream and the corresponding output data stream, wherein the set of input-output pairs comprises a first pair that indicates that when one or more first inputs are fed to the software application, a first output is generated by the software application. The processor is further configured to determine a first cluster comprising a first subset of the set of input-output pairs that is directed to the first operation. The processor is further configured to determine a second cluster comprising a second subset of the set of input-output pairs that is directed to the second operation. The processor is further configured to generate a first source code portion from the first cluster, wherein the generated first source code portion, when executed by the processor, causes the processor to perform the first operation. The processor is further configured to generate a second source code portion from the second cluster, wherein the generated second source code portion, when executed by the processor, causes the processor to perform the second operation. The processor is further configured to generate an aggregated source code by aggregating the first source code portion and the second source code portion, wherein the aggregated source code, when executed by the processor, causes the processor to perform the first operation and the second operation. The processor is further configured to execute the aggregated source code to perform the first operation and the second operation.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement source code generation for a software application based on behavior analysis of the software application;

FIG. 2 illustrates an example operational flow of the system of FIG. 1; and

FIG. 3 illustrates an example flow chart of a method of the system of FIG. 1.

### DETAILED DESCRIPTION

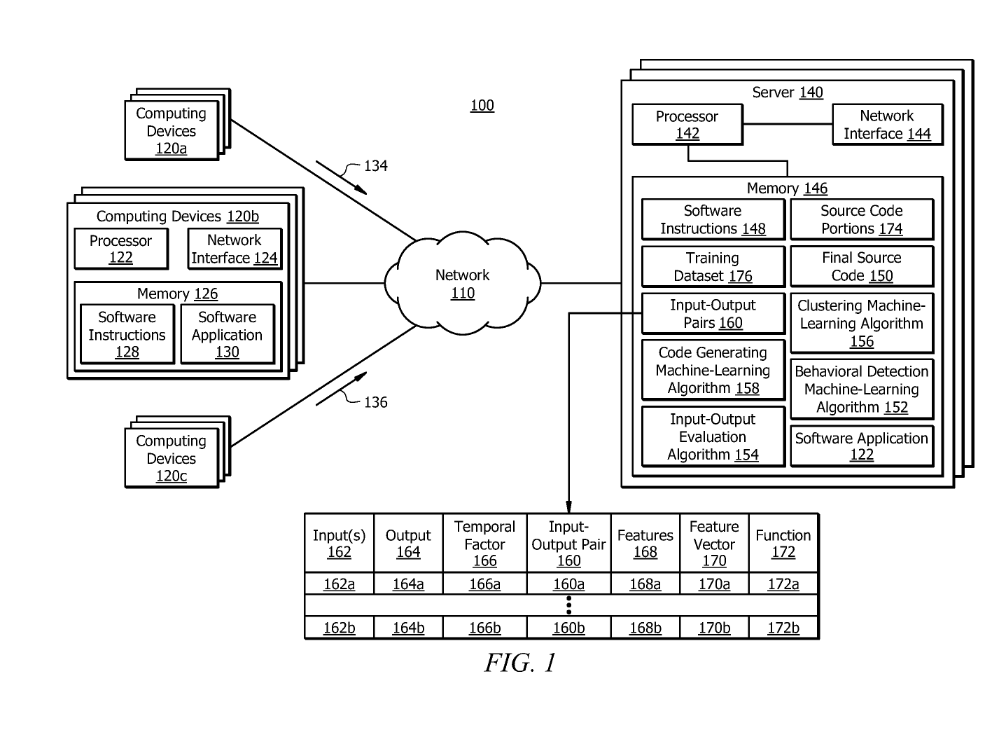

As described above, previous technologies fail to provide efficient and reliable solutions to implement source code generation for a software application based on the behavior analysis of the software application. Embodiments of the present disclosure and its advantages may be understood by referring to FIGS. 1 through 3. FIGS. 1 through 3 are used to describe systems and methods to implement source code generation for a software application based on behavior analysis of the software application, according to some embodiments.

### System overview

FIG. 1 illustrates an embodiment of a system 100 that is generally configured to analyze an input data stream 134 provided to a software application 130 and a corresponding output data stream 136 generated by the software application 130, and generate source code 150 that replicates the determined behavior of the software application 130. In some embodiments, the system 100 comprises a server 140 communicatively coupled with one or more computing devices 120 (e.g., computing devices 120a, 120b, and 120c) via a network 110. The network 110 enables the communication among the components of the system 100. Each computing device 120 may be used to send data to and receive data from other components of the system 100. The server 140 is configured to determine the behavior of the software application 130 (by analyzing the input data stream 134 communicated to the software application 130 and the corresponding output data stream 136 generated by the software application 130) and generate source code 150 that replicates the determined behavior of the software application 130. In other embodiments, system 100 may not have all of the components listed and/or may have other elements instead of, or in addition to, those listed above.

In general, the system 100 improves the source code generation techniques through behavioral analysis of software applications 130. In conventional systems, there may be cases where source code associated with a software application 130 is no longer available. For example, the software application 130 may be a legacy/outdated application or a compromised application where bad actors have hijacked its source code. One approach may be to attempt to reverse engineer the software application 130. However, this approach suffers from several drawbacks. In some examples, reverse engineering may not result in accurate source code of the software application 130 because of the complexity of the function of the software application 130 and/or the relevant manual documents associated with the software application 130 not being available or otherwise not well documented.

The disclosed system 100 is configured to provide a technical solution to these and other technical problems in the realm of software application’s behavioral function recovery. The disclosed system provides several technical improvements to the software application’s behavioral function recovery technology. Some of these technical improvements are described below in conjunction with certain embodiments of the disclosed system.

In some embodiments, instead of attempting to reverse engineer the software application 130 in question, the disclosed system 100 may analyze the behavior of the software application 130 by capturing and analyzing input-output relationships related to various functions 172 of the software application 130, generating a set of clusters 210 of input-output pairs 160 for each identified function 172, and generating a source code portion 174 that when executed by a processor, causes the processor to perform a given function 172. These operations are described in greater detail below.

In some embodiments, analyzing input-output relationships related to various functions 172 of the software application 130 may include detecting a temporal relationship between a sequence of events (e.g., inputs 162) that results in the given output 164 from the software application 130. For example, the disclosed system 100 may determine that when a series of particular events occurs (e.g., certain conditions are met, a specific order of inputs is provided to the software application 130, etc.), the software application 130 generates the respective output 164. Therefore, the disclosed system 100 may detect the temporal factor 166 between the given series of events that led to the respective output. Thus, the disclosed system 100 may detect complex temporal dependencies and patterns within the inputs 162 and the coloration between each ordered inputs 162 and the respective outputs 164 of the software application 130.

In some cases, the disclosed system 100 may detect that an input A has led to multiple outputs 164 by the software application 130 on different occasions. The disclosed system 100 may determine the reason for this anomaly by simulating various one or more orders of inputs 162 followed by the input A to the software application 130 to determine the effect of the previous one or more inputs 162 on the software application 130. In response, the disclosed system 100 may discover a specific sequence of prior inputs 162 (e.g., user inputs, conditions, events) that caused the software application 130 to generate different outputs 164 from the same input A. As an example, the disclosed system 100 may detect a request to compile a piece of code (an input A) that has led to different outputs 164 by the software applications 130 on different occasions. In one instance, the software application 130 may compile the code with no errors, while in another instance, with the same input, the software application 130 may generate an error message. The disclosed system 100 may simulate previous input(s)/event(s) for each instance and determine whether the code had been modified in earlier steps, and whether specific libraries were included or omitted from the code, among others. In response, by analyzing the prior input(s)/event(s) and their temporal relationships, the disclosed system 100 may determine the effect of the prior input(s)/event(s) and their temporal relationships on the behavior of the software application 130. In response, the disclosed system 100 may identify that the different outputs 164 are caused by the specific sequences of prior inputs followed by the same input A, respectively. In this manner, the disclosed system 100 may uncover and model complex temporal and behavioral functions of the software application 130 on various occasions.

In some embodiments, the disclosed system 100 is configured to cluster a given subset of input-output pairs 160 that are determined to be related to the same function 172 of the software application 130. The disclosed system 100 may generate multiple function-specific clusters 210 of input-output pairs 160. In response, the disclosed system 100 may implement a code generating machine learning algorithm to generate a source code portion for each function-specific cluster. The disclosed system 100 may aggregate the generated source code portions, and identify and remove the duplicate code snippets. The disclosed system 100 may generate a finalized source code 150 that behaves as the software application 130 would. In this way, the disclosed system 100 is configured to generate source code 150 that reflects the software application 130’s functional behavior. For example, the disclosed system 100 provides a solution to recover or generate source code of a compromised software application 130 that is hijacked by bad actors, and generate and update source code of a legacy software application 130, whose source code is no longer available.

The disclosed system 100 may conserve computational resources that would otherwise be used to execute obsolete or outdated functions of a software application 130. For example, the disclosed system 100 may detect obsolete or outdated functions of a software application 130 based on comparing with the currently executed and in-demand functions of the software application 130 and generate source code from which those obsolete or outdated functions are removed. Thus, the newly generated source code 150 would require fewer memory resources to be maintained. Further, the disclosed system 100 improves the memory and processing resource utilization at computer systems that host the source code 150 to perform the functions 172 of the software application 130. For example, by removing the obsolete or outdated functions of a software application 130, the disclosed system 100 obviates the need to allocate processing resources to execute and handle those obsolete functions of the software application 130.

### System components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example computing device

Each computing device 120 (e.g., any of computing devices 120a, 120b, and 10c) may be generally any device that is configured to process data and interact with users. Examples of the computing device 120 include but are not limited to, a virtual machine, a personal computer, a desktop computer, a workstation, a server, a laptop, a tablet computer, a mobile phone (such as a smartphone), smart glasses, virtual reality (VR) glasses, a virtual reality device, an augmented reality device, an internet-of-things (IoT) device, or any other suitable type of device. In some embodiments, each computing device 120 may include one or more computing devices residing in one or more data centers in a distributed network. The computing device 120 may include a user interface, such as a display, a microphone, a camera, a keypad, or other appropriate terminal equipment usable by users. The computing device 120 may include a hardware processor, memory, and/or circuitry configured to perform any of the functions or actions of the computing device 120 described herein. Each computing device 120 includes a processor in signal communication with a network interface and a memory. The memory stores software instructions that when executed by the processor cause the processor to perform one or more operations of the computing device described herein. The computing device 120 is configured to communicate with other devices and components of the system 100 via the network 110. A user may use a computing device 120 to transmit data to another device.

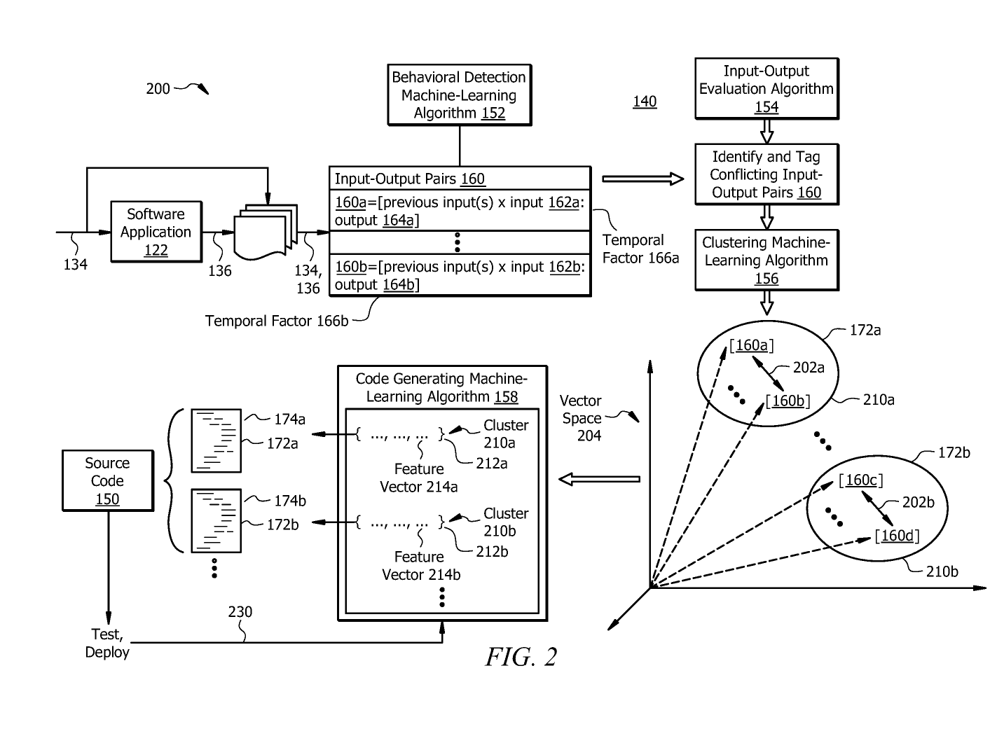

In the example of FIG. 1, one or more computing devices 120a may communicate an input data stream 134 to the software application 130 residing in one or more computing devices 120b. The software application 130 may be implemented in a single computing device 120b or in a distributed network of computing devices 120b. The software application 130 may process the received input data stream 134 and generate the output data stream 136. The computing device(s) 120b may communicate the generated output data stream 136 to the computing device(s) 120c. The server 140 may observe and obtain the input data stream 134 and the output data stream 136 from any of the computing devices 120a, 120b, and 120c. In response, the server 140 may analyze the received data to generate the final source code 150. This process is described in great details in conjunction with FIG. 2.

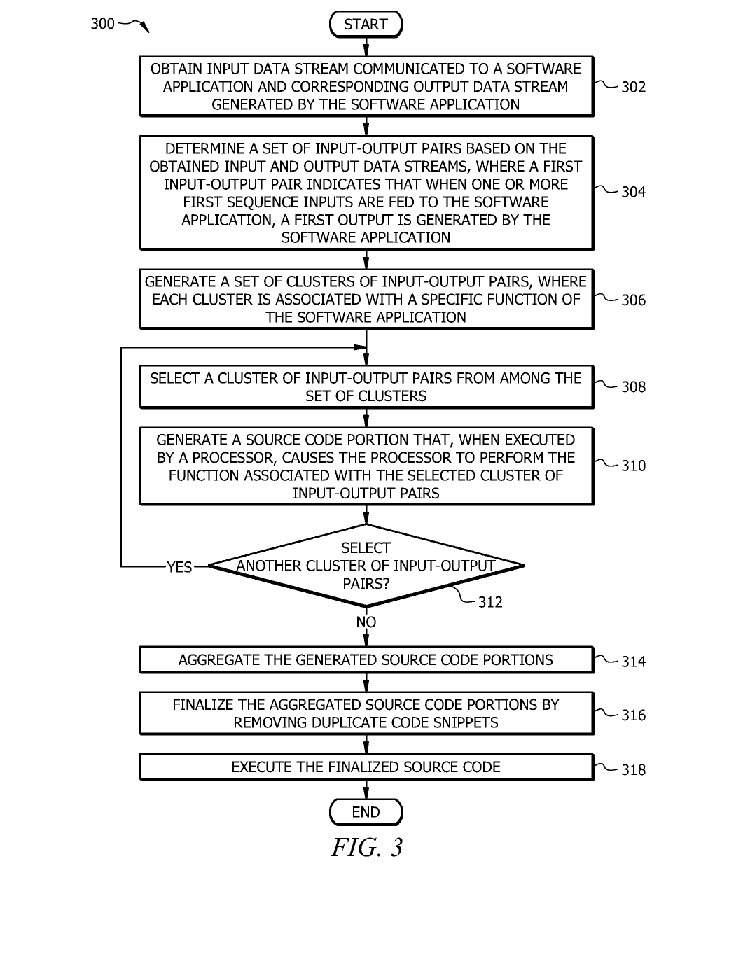

The computing device 120b may comprise a processor 142 operably coupled with a network interface 124 and a memory 126. Processor 142 comprises one or more processors. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128) to perform the operations of the computing device 120b described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 of the system 100 described in FIG. 2 and one or more operations of the method 300 as described in FIG. 3.

Network interface 124 is configured to enable wired and/or wireless communications. The network interface 124 may be configured to communicate data between the computing device 120b and other devices, systems, or domains. For example, the network interface 124 may comprise a near-field communication (NFC) interface, a Bluetooth interface, a Zigbee interface, a Z-Wave interface, a radio-frequency identification (RFID) interface, a wireless fidelity (Wi-Fi) interface, a local area network (LAN) interface, a wide area network (WAN) interface, a metropolitan area network (MAN) interface, a personal area network (PAN) interface, a wireless personal area network (WPAN) interface, a modem, a switch, and/or a router. The processor 142 may be configured to send and receive data using the network interface 124. The network interface 124 may be configured to use any suitable type of communication protocol.

The memory 126 may be a non-transitory computer-readable medium. The memory 126 may be volatile or non-volatile and may comprise read-only memory (ROM), random-access memory (RAM), ternary content-addressable memory (TCAM), dynamic random-access memory (DRAM), and/or static random-access memory (SRAM). The memory 126 may include one or more of a local database, a cloud database, a network-attached storage (NAS), etc. The memory 126 comprises one or more disks, tape drives, or solid-state drives, and may be used as an overflow data storage device, to store programs when such programs are selected for execution, and to store instructions and data that are read during program execution. The memory 126 may store any of the information described in FIGS. 1-3 along with any other data, instructions, logic, rules, or code operable to implement the function(s) described herein when executed by processor 142. For example, the memory 126 may store software instructions 128, software applications 130, and/or any other data or instructions. The software instructions 128 may comprise any suitable set of instructions, logic, rules, or code operable to execute the processor 142 and perform the functions described herein, such as some or all of those described in FIGS. 1-3. The software application 130 may be executed or implemented by the processor 122 executing the software instruction 128. In response, the software application 130 may process the input data stream 134 (received from the computing devices 120a) and generate the output data stream 136, and communicate the output data stream 136 to computing device 120c and/or server 140. Other computing devices 120a and 120c may be the same or substantially similar to the computing device 120b. For example, each computing device 120a and 120c may include a processor 122 in signal communication with a network interface 124 and a memory 126.

### Example Server

The server 140 generally includes a hardware computer system configured to observe the behavior of the software application 130 (by analyzing the input data stream 134 communicated to the software application 130 and the corresponding output data stream 136 generated by the software application 130) and generate source code 150 that replicates the determined behavior of the software application 130. In certain embodiments, the server 140 may be implemented by a cluster of computing devices, such as virtual machines. For example, the server 140 may be implemented by a plurality of computing devices using distributed computing and/or cloud computing systems in a network. In certain embodiments, the server 140 may be configured to provide services and resources (e.g., data and/or hardware resources as described herein, etc.) to other components and devices.

The server 140 may comprise a processor 142 operably coupled with a network interface 144 and a memory 146. Processor 142 comprises one or more processors. The processor 142 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an ALU for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the server 140 described herein. In this way, processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 of the system 100 described in FIG. 2 and one or more operations of the method 300 as described in FIG. 3.

Network interface 144 is configured to enable wired and/or wireless communications. The network interface 144 may be configured to communicate data between the server 140 and other devices, systems, or domains. For example, the network interface 144 may comprise an NFC interface, a Bluetooth interface, a Zigbee interface, a Z-Wave interface, an RFID interface, a Wi-Fi interface, a LAN interface, a WAN interface, a MAN interface, a PAN interface, a WPAN interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise ROM, RAM, TCAM, DRAM, and/or SRAM. The memory 146 may include one or more of a local database, a cloud database, a NAS, etc. The memory 146 comprises one or more disks, tape drives, or solid-state drives, and may be used as an overflow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software applications 130, software instructions 148, behavioral detection machine learning algorithm 152, input-output pairs 160, code generation machine learning algorithm 158, input-output evaluation algorithm 154, source code portions 174, source code 150, clustering machine learning algorithm 156, and a training dataset 176, and/or any other data or instructions. The software instructions 148 may comprise any suitable set of instructions, logic, rules, or code operable to execute the processor 142 and perform the functions described herein, such as some or all of those described in FIGS. 1-3.

The behavioral detection machine learning algorithm 152 may be implemented by the processor 142 executing the software instructions 148 and is generally configured to detect the relationship between each one or more inputs 162 given to the software application 130 with the associated output 164 generated by the software application 130, and associated temporal relationship between the given inputs 162 (e.g., temporal factor 166). The behavioral detection machine learning algorithm 152 may be implemented by a plurality of neural network layers, convolutional layers, long-short-term-memory (LSTM) layers, Bi-directional LSTM layers, recurrent neural network layers, and the like. The behavioral detection machine learning algorithm 152 may be implemented by unsupervised, supervised, and/or semi-supervised machine learning techniques. For example, using an unsupervised machine learning technique, the software application 130 is fed an input data stream 134 (that includes numerous inputs and combinations of sequences of inputs) and, in response, generates a corresponding output data stream 136 (that includes corresponding outputs). The input data stream 134 and output data stream 136 are provided to the behavioral detection machine learning algorithm 152. The behavioral detection machine learning algorithm 152 determines which order and combination of inputs 162 in the input data stream 134 has led to generating the respective output 164. For example, the behavioral detection machine learning algorithm 152 may determine that a first ordered combination of sequence of inputs 162a resulted in output 164b, and a second ordered combination of sequence of inputs 162b resulted in output 164b.

The behavioral detection machine learning algorithm 152 may identify the temporal relations between the given sequence of inputs 162 that led to a given output 164 by observing the order of the inputs 162 being provided to the software application 130. The behavioral detection machine learning algorithm 152 may also determine and associate certain events and/or conditions that led to a given output being generated by the software application 130. For example, the behavioral detection machine learning algorithm 152 may determine that under what condition(s) and/or under what event(s), a particular output 164 is generated by the software application 130. In response, the behavioral detection machine learning algorithm 152 may take the detected condition(s) and/or event(s) as part of factors (as parts of inputs 162) that lead to the given output 164.

The behavioral detection machine learning algorithm 152 may detect that an input 162 (in the input data stream 134) has led to multiple outputs 164 (indicated in the output data stream 136) by the software application 130 on different occasions. The behavioral detection machine learning algorithm 152 may determine the reason for this anomaly by simulating various one or more orders of inputs followed by the input 162 to the software application 130 to determine the effect of previous one or more inputs 162 on the software application 130. In other words, the behavioral detection machine learning algorithm 152 may look for patterns in the input data stream 134 followed by input 162 that led to different outputs 164 and associate/map each identified pattern to the respective output 164. In response, the behavioral detection machine learning algorithm 152 may discover a specific sequence of prior inputs 162 that caused the software application 130 to generate different outputs 164 from the same input 162.

The input-output evaluation algorithm 154 may be implemented by the processor 142 executing the software instructions 148 and is generally configured to detect and mitigate anomalous input-output pairs 160. In some embodiments, the input-output evaluation algorithm 154 may be implemented by object-oriented programming language to evaluate each input 162 and output 164 in a given input-output pair 160 as software object/construct. For example, the input-output evaluation algorithm 154 may detect and remove duplicate input-output pairs 160, keep input-output pairs 160 that include a more optimal output 164, remove outlier pairs 160, remove obsolete pairs 160, and the like. To this end, the input-output evaluation algorithm 154 may compare each input-output pair 160 with other pairs 160 and determine differences and similarities between them. In response, the input-output evaluation algorithm 154 may remove redundant input-output pairs 160. Further, in response, the input-output evaluation algorithm 154 may detect which pair 160 out of a set of pairs 160 that are determined to be redundant, which has led to the software application 130 requiring fewer computational resources to generate the output 164. The input-output evaluation algorithm 154 may keep a particular input-output pair 160 that has been determined to require fewer computational resources, such as memory usage, processing time, or network bandwidth, to generate the output 164.

The input-output evaluation algorithm 154 may identify input-output pairs 160 that include more optimal outputs 164 if the outputs 164 provide more comprehensive information compared to counterpart input-output pairs 160. The input-output evaluation algorithm 154 may identify and remove the input-output pairs 160 that include outputs that are rarely generated by the software application 130 (e.g., less than a threshold number of times, such as less than five over a decade). The input-output evaluation algorithm 154 may identify and remove obsolete input-output pairs 160 that include outputs 164 and/or inputs 162 that are no longer in use.

The clustering machine learning algorithm 156 may be implemented by the processor 142 executing the software instructions 148 and is generally configured to cluster each subset of input-output pairs 160 that are associated with a given operation or function 172 of the software application 130. The clustering machine learning algorithm 156 may comprise a density-based spatial clustering of applications with noise (DBSCAN) algorithm, ordering points to identify the clustering structure (OPTICS) clustering algorithm, a support vector machine neural network, random forest neural network, k-means clustering, etc. The clustering machine learning algorithm 156 may be implemented by a plurality of neural network layers, convolutional layers, long-short-term-memory (LSTM) layers, Bi-directional LSTM layers, recurrent neural network layers, and the like. The clustering machine learning algorithm 156 may be implemented by unsupervised, supervised, and/or semi-supervised machine learning techniques.

The clustering machine learning algorithm 156 may detect which two or more input-output pairs 160 are associated with a given function 172 of the software application 130 by analyzing the patterns and similarities between the inputs 162 and corresponding outputs 164 with respect to the given function 172 of the software application 130. In this process, the clustering machine learning algorithm 156 may extract a set of features from each input-output pair 160 through neural networks, where the extracted features may indicate input type, data structure, the content of inputs, output format, the content of output, temporal relationships between the input events.

The clustering machine learning algorithm 156 may extract such features from each input-output pair 160 to determine which input-output pairs 160 are functionally related. In this process, the clustering machine learning algorithm 156 may extract a first set of features 168a from a first input-output pair 160a (that includes input(s) 162a and output 164a), where the features 168a are represented in a first feature vector 170a that includes numerical values, and extract a second set of features 168b from a second input-output pair 160b (that includes input(s) 162b and output 164b), where the features 168b are represented in a second feature vector 170b that includes numerical values. The clustering machine learning algorithm 156 may determine that the first input-output pair 160a is related to the function 172a of the software application 130 based on the similarity of the feature vector 170a to other input-output pairs 160 that are known to be associated with the function 172a of the software application 130. Similarly, the clustering machine learning algorithm 156 may determine that the second input-output pair 160b is related to or associated with the function 172b of the software application 130 based on the similarity of the feature vector 170b to other input-output pairs 160 that are known to be associated with the function 172b of the software application 130.

The clustering machine learning algorithm 156 may compare the first feature vector 170a with the second feature vector 170b by determining a distance (e.g., Euclidean distance) and/or cosine similarity between them in the vector space 204. The clustering machine learning algorithm 156 may determine that the first input-output pair 160a is functionally related to the second input-output pair 160b if it is determined that the distance between the first feature vector 170a and the second feature vector 170b is less than a threshold distance (e.g., less than 0.1, 0.2, etc.). In other words, the clustering machine learning algorithm 156 may determine that the function 172b corresponds to the function 172a if it is determined that the distance between the first feature vector 170a and the second feature vector 170b is less than a threshold distance (e.g., less than 0.1, 0.2, etc.). In response, the clustering machine learning algorithm 156 may cluster the pairs 160a and 160b together as being related to the same function 172 of the software application 130. Otherwise, the clustering machine learning algorithm 156 may not cluster the pairs 160a and 160b together.

In some embodiments, the clustering machine learning algorithm 156 may group or cluster a group of input-output pairs 160 that are associated with closely spaced feature vectors 170 in the vector space 204. For example, the clustering machine learning algorithm 156 may identify a group of input-output pairs 160 whose feature vectors 170 are located within a local region in the vector space 204 that forms a dense group of data points, e.g., within a region where each neighboring data points are less than a threshold distance 202a-b apart (see FIG. 2). The threshold distance 202a-may be 0.1, 1, 2, etc. The clustering machine learning algorithm 156 may cluster together the identified group of neighboring input-output pairs 160 that form a dense set of data points in a local region in the vector space 204. In this way, the clustering machine learning algorithm 156 may identify multiple clusters of groups of input-output pairs 160 that each form a local dense region in the vector space 204. The input-output pairs 160 that fall outside of all of the identified dense regions of input-output pairs 160 in the vector space 204 are identified as outliers. The clustering machine learning algorithm 156 may disregard and/or remove the outlier input-output pairs 160 from consideration.

The code generating machine learning algorithm 158 may be implemented by the processor 142 executing the software instructions 148 and is generally configured to generate computer programming language source code portion 174 for a given cluster of input-output pairs 160 associated with a function 172. The code generating machine learning algorithm 158 may be implemented by a plurality of neural network layers, convolutional layers, LSTM layers, Bi-directional LSTM layers, recurrent neural network layers, and the like. The code generating machine learning algorithm 158 may be implemented by natural language processing (NLP) models, generative text machine learning models (e.g., large language models (LLMs), generative computer programming language models, and the like.

In some embodiments, the code generating machine learning algorithm 158 may perform, text segmentation, word segmentation, sentence segmentation, text tokenization, word tokenization, and sentence tokenization on a given data (e.g., a cluster of input-output pairs 160) in order to generate the respective code portion 174. In this process, the code generating machine learning algorithm 158 may analyze each input-output pair 160 in the given cluster 210 (see FIG. 2) to understand and determine the relationship between the input(s) 162, the corresponding output 164, and the temporal factor 166 indicating the temporal relationship between the sequence of inputs 162, among other attributes. For example, the code generating machine learning algorithm 158 may feed the received input-output pairs 160 to its neural network to extract a set of features represented in feature vectors, respectively. The code generating machine learning algorithm 158 may use the feature vectors to model the relationships between the inputs 162 and respective outputs 164 to determine the logic that represents the relationships between the inputs 162 and respective outputs 164.

The clustering machine learning algorithm 156 may be implemented by unsupervised, supervised, and/or semi-supervised machine learning techniques. For example, the code generating machine learning algorithm 158 may be trained based on a training dataset 176. The training dataset 176 may include a corpus of text that includes natural language descriptions, each labeled with a corresponding source code snippet. The source code snippets may be from the known and available source codes. Each entry in the training dataset 176 may include a piece of text (e.g., a phrase, a sentence, two or more sentences, training input-output pair 160) labeled with the corresponding source code snippet.

The code generating machine learning algorithm 158 may analyze the relationship between each natural language description (e.g., training input-output pairs 160) and the corresponding source code snippets to identify common patterns, such as how certain phrases in the natural language description are associated with (e.g., corresponds to) a specific programming language construct, such as classes, method, functions, variables, loops, etc., across the input-output pairs 160 in a cluster 210. For example, if context in inputs 162 indicates creating a blueprint construct to be used in various instances, it may be translated into a programming language class (e.g., “class create: . . .”), if the content in inputs 162 indicates performing a function/action, it may be translated into a programming language function (e.g., “def calculate_sum = . . .”), if the content in inputs 162 indicates a repeated task until certain condition is met, it may be translated into a loop programming language construct (e.g., “while not valid_input: . . .”), among others.

In the training process, the code generating machine learning algorithm 158 may extract a set of features from each entry of the training dataset 176, where the features may indicate the relationship between the natural language description and the corresponding source code snippet. The features associated with each entry of the training dataset 176 may be represented in a feature vector comprising numerical values. The code generating machine learning algorithm 158 may analyze the feature vectors to determine the common patterns across various entries of the training dataset 176. The code generating machine learning algorithm 158 may use the identified patterns to develop a translation model that links the natural language input (e.g., training input-output pair 160) into a respective programming language code portion 174. In other words, the code generating machine learning algorithm 158 may translate each cluster of training input-output pairs 160 into a respective source code portion 174. The code generating machine learning algorithm 158 may be configured to learn the programming language syntax from the training dataset 176 and apply it in the code generation process.

The code generating machine learning algorithm 158 may adjust the neural network parameters, such as weight and bias values to increase the accuracy of translation of the input-output cluster into a respective source code portion 174 through backpropagation. In the testing process, the code generating machine learning algorithm 158 may use the intelligence/translation model to process new, unseen natural language inputs (e.g., a cluster of input-output pairs 160) to generate corresponding source code portion 174 that performs or executes the associated function 172. The code generating machine learning algorithm 158 may use certain keywords from the cluster of input-output pairs 160 to name the programming language variables, functions, classes, methods, etc. in the generated source code portion 174.

### Operational flow for source code generation based on behavioral analysis of a software application

FIG. 2 illustrates an example operational flow 200 of system 100 (see FIG. 1) for source code generation based on behavioral analysis of a software application 130. In operation, the operational flow 200 may begin when the server 140 obtains the input data stream 134 communicated to the software application 130 in question and the corresponding output data stream 136 generated by the software application 130. The server 140 may obtain the input data stream 134 from the computing devices 120a (see FIG. 1) and the output data stream 136 from the computing devices 120c (see FIG. 1).

The input data stream 134 may include a set of data inputs 162, such as user inputs, application programming interface (API) calls, parallel processing thread configurations, single processing thread configurations, system configurations (such as CPU utilization, memory utilization, disk input/output), operating system-level events, input-output buffer bandwidth and status, input-output network buffer bandwidth and status, network firewalls, network failures, memory overflows, network packets (including bits), kernel-level events (such as system calls, interrupts, signals), network topology changes (network routings, subnet changes), network traffic, inter-process communications within the software application 130, between the software application 130 and other applications and/or devices in messages indicated by dedicated bits or system signals, among others that would trigger one or more specific functions 172 of the software application 130. The output data stream 136 may include software application 130’s outputs 164 for each given input 162, such as system messages indicated by bits, a requested function being executed, compiled code, API responses, API interactions with other devices and/or software applications, among others. The input data stream 134 may expand over any duration, e.g., one day, one week, etc. The server 140 may determine a set of input-output pairs 160 based on the inputs 162 and corresponding outputs 164, where each input-output pair 160 may include input(s) 162 and the corresponding output 164. Each input-output pair 160 may indicate that when one or more inputs 162 are fed to the software application 130 in a particular order, a respective output 164 is generated by the software application 130.

The server 140 may feed the input-output pairs 160 to the behavioral detection machine learning algorithm 152 to determine the relationship within and among them, and to determine the temporal factor 166 associated with the sequence of the inputs 162. For example, the behavioral detection machine learning algorithm 152 may identify the input-output pair 160a as [previous input(s) x input 162a: output 164a], where the previous input(s) x input 162a indicates a particular sequence of inputs 162a that led to the output 164a. The temporal factor 166a indicates the temporal relationship between the previous input(s) and input 162a. In another example, the behavioral detection machine learning algorithm 152 may identify the input-output pair 160b as [previous input(s) x input 162b: output 164b], where the previous input(s) x input 162b indicates a particular sequence of inputs 162b that led to the output 164b. The temporal factor 166b indicates the temporal relationship between the previous input(s) and input 162b. The behavioral detection machine learning algorithm 152 may determine the temporal factors 166 and other aspects of the input-output pairs 160, similar to that described in FIG. 1.

### Generating function-specific clusters of input-output pairs

The server 140, e.g., via the input-output evaluation algorithm 154, may organize and identify natural language models and categorize them against the use cases (e.g., functions 172) of the software application 130 using the input-output pairs 160. For example, the server 140 e.g., via the input-output evaluation algorithm 154, may detect and remove duplicate input-output pairs 160, keep input-output pairs 160 that include a more optimal output 164, remove outlier pairs 160, remove obsolete pairs 160, and the like, similar to that described in FIG. 1.

The input-output evaluation algorithm 154 may flag conflicting pairs 160, such as two or more different outputs 164 for the same input 162 for further processing by the clustering machine learning algorithm 156. For example, the input-output evaluation algorithm 154 may add a tag to the conflicting pairs 160 as an identifier for further analysis by the clustering machine learning algorithm 156.

The clustering machine learning algorithm 156 may generate a set of function-specific clusters 210, where each cluster 210 includes a group of input-output pairs 160 that are identified to be associated with the same function 172 of the software application 130, e.g., address the same problem. In the example of FIG. 2, the clustering machine learning algorithm 156 may generate a first cluster 210a that includes input-output pairs 160a and 160b that are determined to be directed to the first function 172a of the software application 130, and generate a second cluster 210b that includes input-output pairs 160c and 160d that are determined to be directed to the second function 172b of the software application 130.

In this process, the clustering machine learning algorithm 156 may analyze the features 168 of each input-output pair 160 to determine common patterns across the input-output pairs 160 and classify them into the appropriate clusters 210 based on their associated functions 1172. For example, input-output pairs 160 that share the same or substantially similar input 162 types and formats, output 164 types and formats, and/or temporal factors 166 may be grouped as being related to the same function 172, and therefore, forming a cluster 210. In some examples, each cluster 210a and 210b may include input-output pairs that are related to functions 172, such as verifying user credentials, such as username and password as inputs and authentication message (e.g., failed, success) as the output; account number and calendar date as inputs, and an operation request approval or denial as the output; or digital wallet address and amount as inputs, and approval or denial of transfer as output.

The clustering machine learning algorithm 156 may merge clusters 210 that are associated with overlapping function 172. The clustering machine learning algorithm 156 may split clusters 210 that are associated with sub-functions within the overall function 172, e.g., if the sub-functions may require different logic or operational flow to be implemented in a programming language.

### Generating source code portion for each cluster

The server 140, e.g., via the code generation machine learning algorithm 158, may generate a source code portion 174 that when executed by a processor (e.g., processor 142, processor 122, etc.), causes the processor to perform the associated function 172 related to the given cluster 210, similar to that described in FIG. 1. In this process, the code generation machine learning algorithm 158 may extract a set of features 212 from each cluster 210, via neural networks, and determine a relationship and correlation between a given input 162 and the corresponding output 164 and among the pairs 160 based on the extracted features 212. The extracted features 212 may be represented by a feature vector 214 that comprises numerical values. For example, the extracted features 212 may include attributes, such as input 162 types (e.g., API requests, user inputs) and input 162 content, output 164 formats (e.g., JavaScript object notation (JSON), hypertext markup language (HTML), extensible markup language (XML)), data structures (e.g., arrays, objects, key-value pairs), temporal relationships between inputs and outputs (e.g., the time between input submission and output generation), temporal factor 166 indicating the order of inputs 162, correlation the between the inputs 162 and the corresponding output 164, among others.

The code generation machine learning algorithm 158 may translate the determined features 212 into a functional programming language code structure that when applied to the input 162, the corresponding output 164 is generated based on the features 212. The code generation machine learning algorithm 158 may determine the functional programming language code structure based on the learned intelligence from being trained on the training dataset 176, similar to that described in FIG. 1. The code generation machine learning algorithm 158 may generate the source code portion 174 that includes the determined functional programming language code structure. The functional programming language code structure may include a logical condition (e.g., for statement, while statement), data transformation to generate output 164 based on a sequence of inputs 162, or a combination thereof.

The code generation machine learning algorithm 158 may perform similar operations for each cluster 210a and 210b. For example, the code generation machine learning algorithm 158 may extract a set of features 212a from cluster 210a, via neural networks, and determine a relationship and correlation between given input 162a and 162a and the corresponding outputs 164a and 164b, and among the pairs 160a and 160b based on the extracted features 212a. The extracted features 212a may be represented by a feature vector 214a that comprises numerical values. For example, the extracted features 212a may include attributes, such as input 162a and 162a types (e.g., API requests, user inputs) and input 162a and 162a content, output 164a and 164b formats, data structures (e.g., arrays, objects, key-value pairs), temporal relationships between inputs and outputs (e.g., the time between input submission and output generation), temporal factor 166a and 166b indicating the order of respective inputs, correlation the between the inputs 162a and 162b, and the corresponding output 164a and 164b, among others.

The code generation machine learning algorithm 158 may translate the determined features 212a into a functional programming language code structure that when applied to either input 162a and 162b, the corresponding output 164a and 164b is generated based on the features 212a. The code generation machine learning algorithm 158 may generate the source code portion 174a that includes the determined functional programming language code structure for the cluster 210a. The source code portion 174a when executed by a process (e.g., processor 142, 122) causes the processor to perform the function 172a.

The code generation machine learning algorithm 158 may extract a set of features 212b from cluster 210b, via neural networks, and determine a relationship and correlation between given input 162c and 162d and the corresponding outputs 164c and 164d, and among the pairs 160c and 160d based on the extracted features 212b. The extracted features 212b may be represented by a feature vector 214b that comprises numerical values. For example, the extracted features 212b may include attributes, such as input 162c and 162d types (e.g., API requests, user inputs) and input 162c and 162d content, output 164c and 164d formats, data structures (e.g., arrays, objects, key-value pairs), temporal relationships between inputs and outputs (e.g., the time between input submission and output generation), temporal factor indicating the order of respective inputs 162c and 162d, correlation the between the inputs 162c and 162d, and the corresponding output 164c and 164d, among others. The code generation machine learning algorithm 158 may translate the determined features 212b into a functional programming language code structure that when applied to either input 162c and 162d, the corresponding output 164c and 164d is generated based on the features 212b. The code generation machine learning algorithm 158 may generate the source code portion 174b that includes the determined functional programming language code structure for the cluster 210b. The source code portion 174b, when executed by a process (e.g., processor 142, 122) causes the processor to perform the function 172b.

The code generation machine learning algorithm 158 may determine the name of each functional programming language code structure based on the content of the associated cluster 210 (e.g., including the input-output pairs 160). The code generation machine learning algorithm 158 may identify and add the relevant programming library files to the source code portions 174a-b based on the features 212a-b.

### Consolidating the source code portions

The server 140, e.g., via the code generation machine learning algorithm 158 may aggregate the generated source code portions 174a-b by appending them. The server 140 may consolidate the aggregated source code portions 174a-b by identifying and removing duplicate source code snippets. For example, the server 140 may identify that a first function code from the first source code portion 174a is duplicated in the second source code portion 174b. In response, the server 140 may remove the first function code from either source code portion.

The server 140 may integrate the source code portions 164a-b with each other, such as programming language parameters, variables, functions, and/or classes that are called in one of them are consistently defined and/or used in the other. In other words, the server 140 may link the source code portions 164a-b to be a coherent and functional programming language source code 150. The server 140 may determine and maintain class hierarchies, inheritance, and other aspects in the finalized source code 150.

The server 140 may output the finalized source code 150 to be deployed and implemented to replicate the behavior of the software application 130. For example, the server 140 may execute the source code 150 to perform the functions 174-b of the software application 130. In the same or another example, the server 140 may deploy the source code 150 to be implemented by a distributed network of computing devices 120b (see FIG. 1) to replace the software application 130.

### Refining the generated source code

The server 140 may refine a source code portion 174 if it is determined at least one aspect of the related function 172 is not performed by the source code portion 174. For example, the server 140 may identify a subset of input-output pairs 160 in which a common input 162 has led to multiple outputs 164. In response, the server 140, e.g., via the input-output evaluation algorithm 154 may determine the temporal factor 166 that indicates the order of the inputs 162 preceding the common input 162 in each pair 160 of the identified subset of input-output pairs 160 to determine the sequence of the previous inputs 162 associated with each input-output pair 160. The server 140 may use this information to uncover specific conditions/events (e.g., ordered sequence of inputs 162) preceding the common input 162 that led to different outputs 164. In response, the server 140 may differentiate different use cases for each specific condition/event, and determine functions 172 or sub-functions of the software application 130 that would be triggered under the respective conditions/events.

The server 140 may refine the respective source code portion 174 by incorporating the determined functions 172 or sub-functions and the temporal dependencies and order of inputs 162 preceding the common input 162 in each pair 160. For example, refining the respective source code portion 174 may include providing the additional data points (including the determined functions 172 or sub-functions and the temporal dependencies and order of inputs 162 preceding the common input 162 in each pair 160) to the code generation machine learning algorithm 158 to extract additional features 212 from them and/or revise the existing features 212. In response, the code generation machine learning algorithm 158 may use the additional features 212 and/or revised existing features 212 to generate new code lines and/or revise at least a portion of the existing code lines in the source code portion 174, such that the refined source code portion 174 is configured, when executed by a processor, cause the processor to the newly determined functions 172 or sub-functions.

The server 140 may deploy the source code 150 to replace the software application 130, e.g., by compiling and executing the source code 150 or communicating it to the computing devices 120b to be executed. In response, the source code 150 may be tested with real world inputs 162 to generate respective outputs 164. The server 140 may also feed the same real-world inputs 162 to the software application 130 to generate the respective outputs 164.

The server 140 may compare the real-world input-output pairs (associated with the source code 150) with the corresponding input-output pairs (associated with the software application 130). If any discrepancy between the real-world input-output pairs (associated with the source code 150) and the corresponding input-output pairs (associated with the software application 130) is detected, the server 140 may provide the discrepancy as feedback 230 to the code generation algorithm 158 to address the discrepancy by refining the relevant source code portion 174, similar to that described above. The server 140 may perform iterative testing of the source code 150 with various inputs 162 and refine source code 150 until the behavior of the source code 150 corresponds to the behavior of the software application 130 for each given input(s) 162.

### Example method for source code generation based on behavioral analysis of a software application

FIG. 3 illustrates an example flowchart of a method 300 for source code generation based on behavioral analysis of a software application 130, according to some embodiments. Modifications, additions, or omissions may be made to method 300. Method 300 may include more, fewer, or other operations. For example, operations may be performed in parallel or in any suitable order. While at times it is discussed that the system 100, computing devices 120, server 140, or components of any of thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that when run by one or more processors (e.g., processor 142 of FIG. 1) may cause the one or more processors to perform operations 302-318.

At operation 302, the server 140 obtains the input data stream 134 communicated to a software application 130 and corresponding output data stream 136 generated by the software application 130, similar to that described in FIG. 2.

At operation 304, the server 140 determines a set of input-output pairs 160 based on the obtained input data stream 134 and output data stream 136, where a first input-output pair 160 (e.g., pair 160a) indicates that when one or more first sequence of inputs 162 (e.g., inputs 162a) are fed to the software application 130, a first output 164 (e.g., output 164a) is generated by the software application 130, similar to that described in FIG. 2.

At operation 306, the server 140 generates a set of clusters 210a-b of input-output pairs 160, where each cluster 210a-b is associated with a specific function 172 of the software application 130, similar to that described in FIG. 2.

At operation 308, the server 140 selects a cluster 210 of input-output pairs 160 from among the set of clusters 210a-b. The server 140 may iteratively select a cluster 210 until no cluster 210 is left for evaluation.

At operation 310, the server 140 generates a source code portion 174 that, when executed by a process (e.g., processor 142 or any processor residing in any computing device 120a-c), causes the processor to perform the function 172 associated with the selected cluster 210 of input-output pairs 160, similar to that described in FIG. 2.

At operation 312, the server 140 may determine whether to select another cluster 210 of input-output pairs 160. If it is determined that at least one cluster 210 is left for evaluation, the method 300 returns to operation 308. Otherwise, the method 300 proceeds to operation 314.

At operation 314, the server 140 aggregates the generated source code portions 174, similar to that described in FIG. 2.

At operation 316, the server 140 finalizes the aggregated source code portions 174 by removing duplicate code snippets within the source code portions 174, similar to that described in FIG. 2.

At operation 318, the server 140 executes the finalized source code 150. The server 140 may deploy, test, and refine the finalized source code 150, similar to that described in FIG. 2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a software application associated with a set of operations comprising a first operation and a second operation; and
a processor, operably coupled to the memory, and configured to:
obtain an input data stream communicated to the software application and a corresponding output data stream generated by the software application;
determine a set of input-output pairs based, at least in part, upon the obtained input data stream and the corresponding output data stream, wherein the set of input-output pairs comprises a first pair that indicates that when one or more first inputs are fed to the software application, a first output is generated by the software application;
determine a first cluster comprising a first subset of the set of input-output pairs that is directed to the first operation;
determine a second cluster comprising a second subset of the set of input-output pairs that is directed to the second operation;
generate a first source code portion from the first cluster, wherein the generated first source code portion, when executed by the processor, causes the processor to perform the first operation;
generate a second source code portion from the second cluster, wherein the generated second source code portion, when executed by the processor, causes the processor to perform the second operation;
generate an aggregated source code by aggregating the first source code portion and the second source code portion, wherein the aggregated source code, when executed by the processor, causes the processor to perform the first operation and the second operation; and
execute the aggregated source code to perform the first operation and the second operation.

2. The system of claim 1, wherein generating the first source code portion from the first cluster comprises:
extracting a first set of features from each input-output pair comprised in the first cluster, wherein the first set of features indicates a correlation between a given input and a corresponding output, wherein the first set of features is represented by a set of numerical values in a feature vector; and
determining a functional code structure that when applied to the given input, the corresponding output is generated based at least in part upon the correlation between the given input and the corresponding output.

3. The system of claim 2, wherein the functional code structure comprises a logical condition, data transformation to generate output based on a sequence of inputs, or a combination thereof.

4. The system of claim 2, wherein a name of the functional code structure is determined based at least in part upon the first subset of the set of input-output pairs.

5. The system of claim 1, wherein the processor is further configured to:
identify that a first function code from the first source code portion is duplicated in the second source code; and
in response to identifying that the first function code from the first generated source code portion is duplicated in the second source code, remove the first function code.

6. The system of claim 1, wherein the processor is further configured to:
identify a third subset of the set of input-output pairs in which a common input has led to multiple outputs;
determine a sequence of previous inputs associated with each pair in the third subset by analyzing temporal dependencies and order of inputs preceding the common input in each pair in the third subset; and
refine the first source code portion by incorporating the temporal dependencies and order of inputs preceding the common input in each pair in the third subset.

7. The system of claim 1, wherein each pair in the first subset of the set of input-output pairs is associated with a respective temporal component, wherein the respective temporal component for a given input-output pair indicates an ordered sequence of inputs that leads to a respective output.

8. A method comprising:
obtaining an input data stream communicated to a software application and a corresponding output data stream generated by the software application, wherein the software application is associated with a set of operations comprising a first operation and a second operation;
determining a set of input-output pairs based at least in part upon the obtained input data stream and the corresponding output data stream, wherein the set of input-output pairs comprises a first pair that indicates that when one or more first inputs are fed to the software application, a first output is generated by the software application;
determining a first cluster comprising a first subset of the set of input-output pairs that is directed to the first operation;
determining a second cluster comprising a second subset of the set of input-output pairs that is directed to the second operation;
generating a first source code portion from the first cluster, wherein the generated first source code portion, when executed by a processor, causes the processor to perform the first operation;
generating a second source code portion from the second cluster, wherein the generated second source code portion, when executed by the processor, causes the processor to perform the second operation;
generating an aggregated source code by aggregating the first source code portion and the second source code portion, wherein the aggregated source code, when executed by the processor, causes the processor to perform the first operation and the second operation; and
executing the aggregated source code to perform the first operation and the second operation.

9. The method of claim 8, wherein generating the first source code portion from the first cluster comprises:
extracting a first set of features from each input-output pair comprised in the first cluster, wherein the first set of features indicates a correlation between a given input and a corresponding output, wherein the first set of features is represented by a set of numerical values in a feature vector; and
determining a functional code structure that when applied to the given input, the corresponding output is generated based at least in part upon the correlation between the given input and the corresponding output.

10. The method of claim 9, wherein the functional code structure comprises a logical condition, data transformation to generate output based on a sequence of inputs, or a combination thereof.

11. The method of claim 9, wherein a name of the functional code structure is determined based at least in part upon the first subset of the set of input-output pairs.

12. The method of claim 8, further comprising:
identifying that a first function code from the first source code portion is duplicated in the second source code portion; and
in response to identifying that the first function code from the first generated source code portion is duplicated in the second source code portion, removing the first function code.

13. The method of claim 8, further comprising:
identifying a third subset of the set of input-output pairs in which a common input has led to multiple outputs;
determining a sequence of previous inputs associated with each pair in the third subset by analyzing temporal dependencies and order of inputs preceding the common input in each pair in the third subset; and
refining the first source code portion by incorporating the temporal dependencies and order of inputs preceding the common input in each pair in the third subset.

14. The method of claim 8, wherein each pair in the first subset of the set of input-output pairs is associated with a respective temporal component, wherein the respective temporal component for a given input-output pair indicates an ordered sequence of inputs that leads to a respective output.

15. A non-transitory computer-readable medium storing instructions that, when executed by a processor, cause the processor to:
obtain an input data stream communicated to a software application and a corresponding output data stream generated by the software application, wherein software application is associated with a set of operations comprising a first operation and a second operation;
determine a set of input-output pairs based, at least in part, upon the obtained input data stream and the corresponding output data stream, wherein the set of input-output pairs comprises a first pair that indicates that when one or more first inputs are fed to the software application, a first output is generated by the software application;
determine a first cluster comprising a first subset of the set of input-output pairs that is directed to the first operation;
determine a second cluster comprising a second subset of the set of input-output pairs that is directed to the second operation;
generate a first source code portion from the first cluster, wherein the generated first source code portion, when executed by the processor, causes the processor to perform the first operation;
generate a second source code portion from the second cluster, wherein the generated second source code portion, when executed by the processor, causes the processor to perform the second operation;
generate an aggregated source code by aggregating the first source code portion and the second source code portion, wherein the aggregated source code, when executed by the processor, causes the processor to perform the first operation and the second operation; and
execute the aggregated source code to perform the first operation and the second operation.

16. The non-transitory computer-readable medium of claim 15, wherein generating the first source code portion from the first cluster comprises:
extracting a first set of features from each input-output pair comprised in the first cluster, wherein the first set of features indicates a correlation between a given input and a corresponding output, wherein the first set of features is represented by a set of numerical values in a feature vector; and
determining a functional code structure that when applied to the given input, the corresponding output is generated based at least in part upon the correlation between the given input and the corresponding output.

17. The non-transitory computer-readable medium of claim 16, wherein the functional code structure comprises a logical condition, data transformation to generate output based on a sequence of inputs, or a combination thereof.

18. The non-transitory computer-readable medium of claim 16, wherein a name of the functional code structure is determined based at least in part upon the first subset of the set of input-output pairs.

19. The non-transitory computer-readable medium of claim 15, wherein the instructions further cause the processor to:
identify that a first function code from the first source code portion is duplicated in the second source code portion; and
in response to identifying that the first function code from the first generated source code portion is duplicated in the second source code portion, remove the first function code.

20. The non-transitory computer-readable medium of claim 15, wherein the instructions further cause the processor to:
identify a third subset of the set of input-output pairs in which a common input has led to multiple outputs;
determine a sequence of previous inputs associated with each pair in the third subset by analyzing temporal dependencies and order of inputs preceding the common input in each pair in the third subset; and
refine the first source code portion by incorporating the temporal dependencies and order of inputs preceding the common input in each pair in the third subset.
